(19) United States
(12) Patent Application Publication
(10) Pub. No.: US 2007/0231736 A1
(43) Pub. Date: Oct. 4, 2007

(54) Bottom antireflective coating composition and method for use thereof

(76) Inventors: Kuang-Jung J. Chen, Poughkeepsie, NY (US); Mahmoud Khojasteh, Poughkeepsie, NY (US); Ranee Wai-Ling Kwong, Wappingers Falls, NY (US); Wenjie Li, Poughkeepsie, NY (US); Kaushal Patel, Wappingers Falls, NY (US); Pushkara R. Varanasi, Poughkeepsie, NY (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/391,187

(22) Filed: Mar. 28, 2006

(51) Int. Cl. G03C 1/00

(52) U.S. Cl. 430/270.1

(57) ABSTRACT

The present invention discloses an antireflective coating composition for applying between a substrate surface and a photoresist composition. The antireflective coating composition of the present invention comprises a polymer, which includes at least one monomer unit containing a lactone moiety and at least one monomer unit containing an absorbing moiety. The inventive antireflective coating composition is preferably organic solvent-strippable, insoluble in an aqueous alkaline developer for the photoresist composition after exposure to an imaging radiation, and inert to contact reactions with the photoresist composition. The present invention also discloses a method of forming patterned material features on a substrate using the compositions of the invention.

### FIELD OF THE INVENTION

This invention relates to an antireflective coating composition for use with an overlying photoresist. More particularly, this invention is directed to an organic solvent strippable bottom antireflective coating composition comprising a polymer that includes at least one monomer unit containing a lactone moiety and at least one monomer unit containing an absorbing moiety. The present invention also provides a method for forming and transferring a relief image by using the inventive antireflective coating composition in photolithography.

### BACKGROUND OF THE INVENTION

In a photolithography process, exposure of a photoresist to activating radiation is an important step in attaining a high resolution photoresist image. However, reflection of activating radiation from the photoresist and the underlying substrate substantially limits the resolution of a lithography process. Two major problems of reflected radiation are: (1) thin film interference effects or standing waves, which are casued by variations in the total light intensity in the photoresist film as the photoresist thickness changes; and (2) relective notching, which occurs when the photoresist is patterned over substrates containing topographical features.

As semiconductor manufactures have sought to fabricate devices having a higher degree of circuit integration to improve device performance, it has become necessary to use photolithographic techniques using shorter wavelengths (300 nm or less in wavelength) in the mid and deep ultraviolet (UV) spectra to achieve fine features. The use of shortened wavelengths of light for imaging a photoresist coating has resulted in increased reflection from the upper resist surface as well as the surface of the underlying substrate.

To reduce the problem of reflected radiation, prior art processes typically use a radiation-absorbing layer interposed between the substrate surface and the photoresist coating layer. Such an antireflective layer is also referred to as a bottom antireflective coating, i.e., BARC.

One class of prior art BARC materials is polymers based on crosslinking chemistry (see, for example, U.S. Pat. No. 5,939,236, U.S. Pat. No. 6,503,689, U.S. Pat. No. 6,610,457, and U.S. Pat. No. 6,261,743). This class of BARC materials typically includes one or more polymeric binders, a crosslinking agent, and an acid or a thermal or photo acid generator. The BARC materials based on crosslinking chemistry usually need to be heated at a relatively high temperature (e.g., >150° C.) to induce a crosslinking reaction thereby making the BARC layer insoluble in common organic solvents as well as in an aqueous alkaline developer solution. The crosslinked BARC layer generally has desirable resistance to photoresist casting solvents, and thereby prevents intermixing of the BARC layer and the photoresist. However, since the crosslinked BARC is insoluble in most organic solvents and developers, it often requires stripping techniques, such as ashing or dry etching, to remove the BARC layer. The harsh stripping conditions associated with the aforesaid techniques often cause damages to the substrate. Another disadvantage of using the crosslinked BARC layer is that the acid or the thermally or photo generated acid residue in the BARC layer may diff-use to the photoresist/BARC interface causing adverse effects, such as undercut in a positive resist or footing in negative resist.

Other prior art BARC materials include polymers containing strong aromatic groups. For example, the BARC materials disclosed in U.S. Pat. No. 5,654,376, U.S. Pat. No. 5,800,963, and U.S. Pat. No. 6,051,364 are based on aromatic imide; U.S. Pat. No. 5,401,614 describes a BARC material comprising a polymer selected from the group consisting of poly(vinylnaphthalenes), poly(acenaphthalenes), and poly(vinylbiphenyls); and U.S. Pat. No. 5,554,485 and U.S. Pat. No. 5,607,824 describes an antireflective coating composition comprising poly(arylethers). However, these aromatic BARC materials have too high an absorption and too low a dry etch rate to be useful in short wavelength photolithography, such as 193nm lithography and below.

Thus, there remains a need for an antireflective coating composition that is strippable by common organic solvents, insoluble in an aqueous alkaline developer after exposure to light, compatible with photoresists, and has desired optical properties so that it can be used as a BARC in short wavelength photolithography.

### SUMMARY OF THE INVENTION

Accordingly, the present invention provides an antireflective coating composition for applying between a substrate surface and a photoresist layer. The antireflective coating composition of the present invention comprises a polymer, which includes at least one monomer unit containing a lactone moiety and at least one monomer unit containing an absorbing moiety. The inventive antireflective coating composition is preferably organic solvent-strippable, insoluble (as defined below) in an aqueous alkaline developer for the photoresist composition after exposure to an imaging radiation, and inert to contact reactions with the photoresist composition. Preferably, the at least one monomer unit containing a lactone moiety has the following structure: 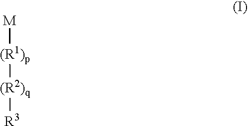
wherein M is a polymerizable backbone moiety; R¹ is a linkage moiety selected from the group consisting of —C(O)O—, —C(O)—, —OC(O)—, and —OC(O)C(O)O—; R² is an alkylene group having 1 to 10 carbon atoms, an arylene group having 5 to 20 atoms, a perfluorinated alkylene group having 1 to 10 carbon atoms, a semifluorinated alkylene group having 1 to 10 carbon atoms, a perfluorinated arylene group having 5 to 20 carbon atoms, or a semifluorinated arylene group having 5 to 20 carbon atoms; R³ is a lactone moiety having 3 to 20 carbon atoms; and p and q are the same or different, and are an integer of 0 or 1. Preferably, the absorbing moiety comprises an aromatic compound.

The present invention also provides a method of forming a patterned material feature on a substrate. The method comprises the steps of:
(a) providing a material surface on a substrate,
(b) forming a layer of the inventive antireflective coating composition over the material surface,
(c) forming a photoresist layer over the antireflective coating,
(d) patternwise exposing the photoresist layer to radiation thereby creating a pattern of radiation-exposed regions in the photoresist layer,
(e) selectively removing portions of the photoresist layer to expose portions of the antireflective coating,
(f) selectively removing the exposed portions of the antireflective coating to expose portions of the material surface, and
(g) transferring the pattern to the material surface at the exposed portions of the material, thereby forming the patterned material feature.

The transferring of step (g) preferably comprises a technique selected from the group consisting of etching and ion implanting.

These and other aspects of the invention are described in further detail below.

### BRIEF DESCRIPTION OF THE DRAWINGS

FIGS. 1A and 1B are scanning electron micrographs showing partial sectional views of photoresist lines and spaces after processing with, and without, the inventive antireflective coating composition.

### DETAILED DESCRIPTION OF THE INVENTION

The present invention is directed to an antireflective coating composition for applying between a substrate surface and a photoresist composition. The photoresist composition may be a non-silicon-containing resist or a silicon-containing resist. The antireflective coating composition does not rely on crosslinking chemistry to achieve resistance to photoresist casting solvents. The antireflective coating composition comprises a polymer that comprises at least one monomer unit containing a lactone moiety and at least one monomer unit containing an absorbing moiety. The antireflective coating composition is preferably inert to contact reactions with an overlying photoresist composition. The term “inert to contact reactions” as used herein denotes that the inventive antireflective coating composition does not substantially intermix with the overlying photoresist composition, and forms a discrete underlayer. The antireflective coating composition is preferably insoluble in an aqueous alkaline developer for the photoresist composition both before and after exposure to an imaging radiation. It should be noted that the inventive antireflective coating can be referred to as a BARC.

Preferably, the monomer unit containing a lactone moiety of the inventive polymer has the following structure: 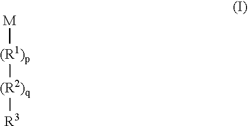
wherein M is a polymerizable backbone moiety; R¹ is a linkage moiety selected from the group consisting of —C(O)O—, —C(O)—, —OC(O)—, and —OC(O)C(O)O—; R² is an alkylene group having 1 to 10 carbon atoms, an arylene group having 5 to 20 atoms, a perfluorinated alkylene group having 1 to 10 carbon atoms, a semifluorinated alkylene group having 1 to 10 carbon atoms, a perfluorinated arylene group having 5 to 20 carbon atoms, or a semifluorinated arylene group having 5 to 20 carbon atoms; R³ is a lactone moiety having 3 to 20 carbon atoms; and p and q are the same or different, and are an integer of 0 or 1.

By “perfluorinated”, it is meant all the hydrogen atoms on the carbon backbone of an organic compound or radical are substituted by fluorine atoms. By “semifluorinated”, it is meant a portion of the hydrogen atoms on the carbon backbone of an organic compound are substituted by fluorine atoms.

The term “polymerizable backbone moiety” as used herein denotes an organic radical that can readily undergo polymerization. Preferably, the polymerizable backbone moiety, i.e., M, in formula (I) is an organic radical containing one or more vinyl groups. More preferably, the polymerizable backbone moiety, i.e., M, in formula (I) has one of the following two structures: 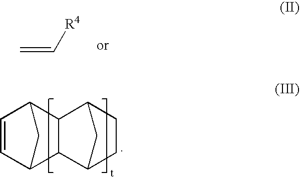
wherein R⁴ is a hydrogen atom, an alkyl group having 1 to 20 carbon atoms, a perfluorinated alkyl group having 1 to 20 carbon atoms, a semifluorinated alkyl group having 1 to 20 carbon atoms, or cyano; t is an integer of 0 to 3. The terms “perflurinated” and “semifluorinated” have the same meanings as defined above. Examples of perfluorinated and semifluorinated alkyl groups suitable for the present invention include, but are not limited to: trifluoromethyl, pentafluoroethyl, and trifluoroethyl. The alkyl group having 1 to 20 carbon atoms may be straight, branched, or cyclic. Preferably, R⁴ is a hydrogen atom, methyl, or perfluorinated methyl.

As used herein, the term “C(O)” denotes a carbonyl group. The linkage moiety expressed as “-linkage-” denotes a linkage in the manner as follows: M-linkage-(R²)_{q}. For example, “—C(O)O—” denotes a linkage as follows: M-C(O)O—(R²)_{q}. Preferably, the linkage moiety of the present invention, i.e., R¹, is —C(O)O—.

The alkylene group having 1 to 10 carbon atoms may be straight, branched, or cyclic. Examples of alkylene group suitable for the present invention include, but are not limited to: methylene, ethylene, n-propylene, iso-propylene, n-butylene, n-pentylene, cyclopentylene, hexylene, and cyclohexylene. The term “arylene” as used herein denotes an organic radical derived from an aromatic compound by the removal of two hydrogen atoms. The aromatic compound may be a hydrocarbon compound or a compound containing one or more heteroatoms selected from nitrogen, oxygen, sulfur, or a combination thereof. The aromatic compound may be monocyclic or polycyclic. The rings in the polycyclic aromatic compound may be fused or non-fused. Examples of aromatic compound suitable for the present invention include, but are not limited to: benzene, toluene, xylene, naphthalene, indene, pentalene, fluorene, phenalene, furan, and thiophene. The terms “perfluorinated” and “semifluorinated” have the same meanings as defined above. Examples of perfluorinated and semifluorinated alkylene groups suitable for the present invention include, but are not limited to: difluoromethylene, tetrafluoroethylene, and difluoroethylene.

The term “a lactone moiety” as used herein denotes a cyclic ester, which is the condensation product of an alcohol group and a carboxylic acid group in the same molecule. The lactone moiety, represented as R³ in formula (I), may be monocyclic or polycyclic. The rings in the polycyclic lactone moiety may be fused or non-fused. Preferably, the lactone moiety is a beta-lactone, a gamma-lactone, or a delta-lactone. It is understood by one skilled in the art that the prefixes, such as beta, gamma, and delta, indicate the ring size of a lactone. That is, a beta-lactone, a gamma-lactone, and a delta-lactone denote a 4-membered, a 5-membered, and a 6-membered lactone ring, respectively. Examples of the lactone moiety suitable for the present invention include, but are not limited to: beta-propiolactone, gamma-butyrolactone, 2,6-norbornane-gamma-carbolactone, and 2,6-norbornane-delta-carbolactone. The lactone moiety of the present invention may be further substituted by other chemical groups, such as an alkyl group having 1 to 6 carbon atoms, halogen, hydroxyl, cyano, and an alkxoyl having 1 to 6 carbon atoms.

In exemplary embodiments of the present invention, the at least one monomer unit containing a lactone moiety may include, but is not limited to:

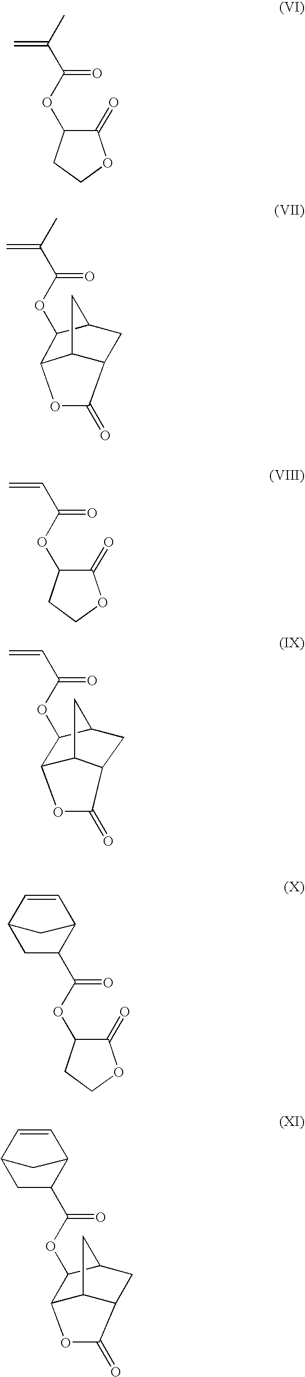

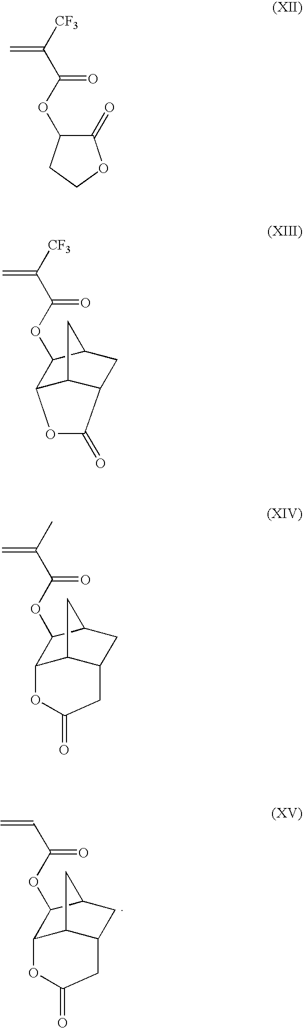

Prefereably, the absorbing moiety comprises an aromatic compound. The aromatic compound may be a hydrocarbon compound or a compound containing one or more heteroatoms selected from nitrogen, oxygen and sulfur. The aromatic compound may be monocyclic or polycyclic. The rings in the polycyclic aromatic compound may be fused or non-fused. Examples of the aromatic compounds suitable for the present invention include, but are not limited to: benzene, toluene, xylene, naphthalene, indene, pentalene, fluorene, phenalene, furan, and thiophene. In the present invention, the aromatic compounds may be further substituted by other chemical groups, such as an alkyl group having 1 to 10 carbon atoms, a perfluorinated alkyl group having 1 to 10 carbon atoms, a semifluorinated alkyl group having 1 to 10 carbon atoms, halogen, hydroxyl, cyano, and an alkxoyl having 1 to 10 carbon atoms. The terms “perfluorinated” and “semifluorinated” have the same meanings as defined above. Preferably, the aromatic compound in the absorbing moiety of the present invention is selected from the group consisting of unsubstituted benzene, substituted benzene, unsubstituted naphthalene, and substituted naphthalene.

In the present invention, the lactone moiety and the absorbing moiety may be in the same or different monomer units. In other words, the inventive polymer may comprise at least one monomer unit containing a lactone moiety and an absorbing moiety, or the inventive polymer may comprise at least one monomer unit containing a lactone moiety and at least one co-monomer unit containing an absorbing moiety. In other words, it is within the scope of the present invention that the lactone moiety and the absorbing moiety are in the same monomer unit of the inventive polymer.

In a preferred embodiment of the present invention, the polymer comprising at least one monomer unit containing a lactone moiety and at least one monomer unit containing an absorbing moiety including one of the following four structures: 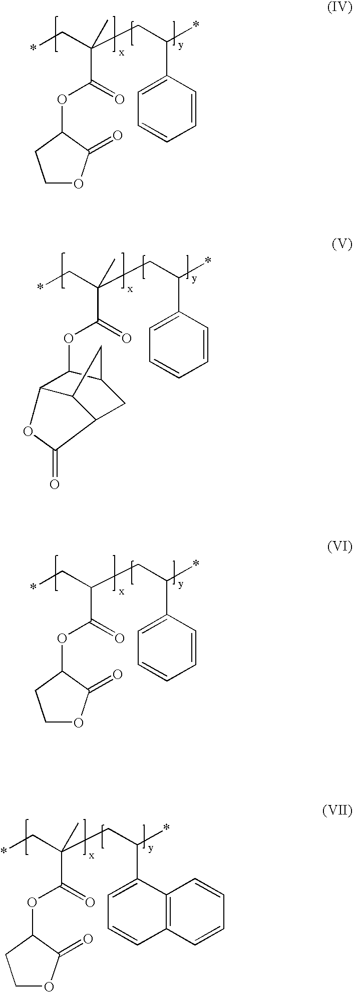
wherein x and y are the same or different, are independently an integer of 10 to 500. Preferably, x and y are in a ratio of about 9:1 to about 7:3.

It is preferred that the inventive antireflective coating composition is soluble in an organic solvent both before and after post applying bake (PAB). Preferred organic solvents include, but are not limited to: a ketone, a lactone, and a combination thereof. Thus, the inventive antireflective coating composition can be readily stripped by these organic solvents thereby avoiding harsh rework conditions and simplifying the rework process. By “soluble” it is meant having a solubility of at least 10 mg per milliliter in a solvent at room temperature. Preferably, the ketone includes, but is not limited to, a cyclic ketone. Examples of cyclic ketone solvents suitable for the present invention include, but are not limited to: cyclohexanone and cyclopentaone. Examples of the lactone suitable for the present invention include, but are not limited to: gamma-butyrolactone, gamma-valerolactone, and delta-valerolactone.

It is preferred that the inventive antireflective coating composition is insoluble (as defined below) in photoresist casting solvents that include, but are not limited to: esters and ethers. Thus, the inventive antireflective coating composition can form a discrete underlayer immiscible with a photoresist layer. In other words, a layer of the inventive antireflective coating composition does not intermix with the above photoresist layer. By “insoluble” it is meant having a solubility of no more than 1 mg per milliliter in a solvent at room temperature. Examples of photoresist casting solvents include, but are not limited to: propylene glycol methyl ether acetate (PGMEA) and ethoxy ethyl propionate (EEP).

The inventive antireflective coating composition is preferably insoluble in an aqueous alkaline developer for a photoresist after exposure to an imaging radiation so that the antireflective coating will not be removed during the development of the photoresist. This would prevent the formation of undercut profiles and line collapse. The word “insoluble” has the same meaning as defined above. Examples of aqueous alkaline developers for photoresists include, but are not limited to: 0.263 N tetramethyl ammonium hydroxide (TMAH).

It is preferred that the inventive polymer has a refractive index (n) in the range from about 1.4 to about 2.2 and an absorption parameter (k) in the range from about 0.1 to about 1.0 at a wavelength of 248 nm, 193 nm, or other extreme ultraviolet radiation. In other words, the inventive antireflective composition is highly absorbent to radiation in the deep and extreme UV region. Furthermore, the inventive antireflective coating composition preferably has a relatively low dry etch rate relative to a 193 nm photoresist. Thus, the inventive antireflective composition is particularly suitable to be used as a BARC film with 193 nm photoresist compositions.

It is also preferable that the inventive polymer has a tunable polymer molecular weight with a weight average molecular weight ranging from about 3K to about 500K Daltons to enable the formulation of high solid content spin castable solutions with adequate viscosity. More preferably, the weight average molecular weight of the inventive polymer ranges from about 5K to about 200K Daltons. The resistance of the inventive antireflective coating composition to photoresist casting solvents improves upon increasing the polymer molecular weight. Co-monomers can also be added as described to prepare copolymer materials with improved mechanical durability and to adjust the refractive index of the coating.

The present invention is further directed to a coating of the inventive antireflective coating composition. The inventive antireflective coating can be used between the substrate and the photoresist layer to reduce the problem of reflected radiation. Preferably, the inventive antireflective coating has a thickness ranging from about 10 nm to about 500 nm, with about 30 nm to about 200 nm more preferred.

In another aspect of the invention, the inventive antireflective coating composition may be used in a method of forming and transferring a relief image by photolithography, more preferably a method for forming a patterned material feature on a substrate. The method preferably comprises:
(a) providing a material surface on a substrate,
(b) forming a layer of the inventive antireflective coating composition over the material surface,
(c) forming a photoresist layer over the antireflective coating,
(d) patternwise exposing the photoresist layer to radiation thereby creating a pattern of radiation-exposed regions in the photoresist layer,
(e) selectively removing portions of the photoresist layer to expose portions of the antireflective coating,
(f) selectively removing the exposed portions of the antireflective coating to expose portions of the material surface, and
(g) transferring the pattern to the material surface at the exposed portions of the material, thereby forming the patterned material feature.

The material surface of the substrate may be a semiconducting material, a dielectric material, a conductive material, or any combinations thereof, including multilayers.

In the inventive method, the inventive antireflective coating composition is first applied on the material surface of substrate by known means, such as spinning, casting, and dipping, to form an antireflective layer on the substrate. The substrate with the antireflective layer may then be baked (post-applying bake) to remove any solvent from the inventive antireflective coating composition and improve the coherence of the antireflective layer. Typical post applying bake temperature is about 90° to about 150° C., and typical post applying bake time is about 60 to 90 seconds. That is, unlike the prior art method using BARC materials based on crosslinking chemistry, the method of the present invention does not require a high bake temperature (e.g., >150° C.) thereby substantially reducing potential damages to the underlying substrate.

A photoresist composition (positive, negative, or hybrid) is then applied over the antireflective layer by known means to form a photoresist layer. The substrate with the photoresist layer may then be baked (post-applying bake or PAB) to remove any solvent from the photoresist composition and improve the coherence of the photoresist layer. A typical photoresist PAB temperature is about 90° to about 130° C. Typical photoresist thickness is about 50 to about 300 nm. Any suitable photoresist composition may be used; examples of some suitable photoresist compositions are disclosed in U.S. Pat. Nos. 6,806,026 B2, 6,949,325 B2, 6,770,419 B2, and U.S. patent application Ser. No. 10/753,989, filed Jan. 8, 2004, the disclosures of which are incorporated herein by reference. The photoresist is preferably one which is imageable using 193 nm radiation.

Next, the substrate is exposed to an appropriate radiation source through a patterned mask to form a latent image. In one exemplary embodiment, the imaging radiation is 193 nm radiation. In another embodiment, the imaging radiation is 248 nm radiation. The exposed substrate may then be baked (post-exposure bake) to promote the chemical reaction in the photoresist and to improve the coherence of the photoresist and coating layers. Typical post-exposure bake temperature is about 90° to about 130° C., and typical post-exposure bake time is about 60 to 90 seconds.

The latent image is then developed to form a relief image pattern in the photoresist layer. That is, the exposed substrate is contacted with an aqueous base developer, such as 0.263 N tetramethyl ammonium hydroxide, thereby removing a portion of the photoresist layer from the substrate to expose portions of the antireflective layer whereby a patterned photoresist layer on the antireflective layer. The invention is not limited to any specific developer.

The pattern in the photoresist layer may then be transferred to the antireflective layer by removing portions of the antireflective layer not covered by the patterned photoresist layer. Typically, portions of the antireflective layer are removed by reactive ion etching or some other etching technique known to the ordinarily skilled in the art. This removal results in exposure of portions of the underlying material surface.

The pattern may then be transferred to the material surface by any know technique. Preferably, the transfer comprises a technique selected from the group consisting of etching (e.g., reactive ion etching or wet etching) and ion implanting. Once the desired pattern transfer has taken place, any remaining resist may be removed using conventional stripping techniques.

Examples of general lithographic processes where the compositions of the invention may be useful are disclosed in U.S. Pat. Nos. 4,855,017; 5,362,663; 5,429,710; 5,562,801; 5,618,751; 5,744,376; 5,801,094; 5,821,469 and 5,948,570, the disclosures of which patents are incorporated herein by reference. It should be understood that the invention is not limited to any specific lithography technique or device structure.

The compositions of the invention and resulting lithographic structures can be used to create various patterned material structures. In the case of integrated circuits, examples of such structures include metal wiring lines, holes for contacts or vias, insulation sections (e.g., damascene trenches or shallow trench isolation), trenches for capacitor structures, etc.

The following examples are provided to illustrate the inventive antireflective coating composition and some advantages in using the same.

### EXAMPLE 1

### Synthesis of Poly(gamma-butyrolactonemethacrylate-co-styrene) (P1)

0.49 g (0.0030 mol) of 2,2′-azobisisobutyronitrile (AIBN) was added to a solution of 1.04 g (0.01 mol) of styrene, 6.80 g (0.04 mol) of gamma-butrolactonemethacrylate (VI), and 0.20 g (0.0001 mol) dodecanethiol in 40 g of 2-butanone. The resulting solution was deoxygenated by bubbling dry N₂ gas through for 0.5 hour and then allowed to reflux for 12 hr. The reaction mixture was cooled to room temperature and precipitated in 400 mL of heptane with rigorous stirring. The resulting white solid was collected by filtration, washed with several portions of hexanes, and dried under vacuum at 60° C. for 20 hr. The weight average molecular weight (Mw) of this polymer was measured to be 6,700 Daltons by gel permeation chromatography (GPC).

### EXAMPLE 2

### Synthesis of Poly(gamma-butyrolactonemethacrylate-co-styrene) (P2)

0.123 g (0.00075 mol) of 2,2′-azobisisobutyronitrile (AIBN) was added to a solution of 1.04 g (0.01 mol) of styrene, 6.80 g (0.04 mol) of gamma-butrolactonemethacrylate (VI), 0.075 g (0.0037 mol) dodecanethiol in 35 g of 2-butanone. The resulting solution was deoxygenated by bubbling dry N₂ gas through for 0.5 hr and then allowed to reflux for 12 hr. The reaction mixture was cooled to room temperature and precipitated in 400 mL of heptane/PGMEA (60/40) with rigorous stirring. The resulting white solid was collected by filtration, washed with several portions of hexanes, and dried under vacuum at 60° C. for 20 hr. The weight average molecular weight (Mw) of this polymer was measured to be 24,230 Daltons by GPC.

### EXAMPLE 3

### PGMEA-Resistance Test

For the purpose of evaluating the PGMEA-resistance of the inventive antireflective coating composition, P1 and P2 synthesized in Examples 1 and 2 were used. Both P1 and P2 had a structure of formula (IV), wherein P1 has a molecular weight of 6,700 Daltons and P2 had a molecular weight of 24,230 Daltons. P1 and P2 were separately applied to two substrates to form BARC films and baked at 150° C. for 90 seconds. The thickness of each BARC films was then measured. Next, the BARC films were rinsed with PGMEA for 15 seconds and then baked at 110° C. for 60 seconds. The center and edge thickness of each BARC films was then measured.

As indicated in Table 1, there is little change in thickness before and after PGMEA rinse demonstrating PGMEA-resistance of the inventive antireflective coating composition.

TABLE 1

| | Molecular | Thickness | Thickness | Thickness |
|---|---|---|---|---|
| | Weight | before | (center) after | (edge) |
| Polymer | (Daltons) | Rinse (Å) | Rinse (Å) | after Rinse (Å) |
| P1 | 6,700 | 2,580 | 2,525 | 2,549 |
| P2 | 24,230 | 1,062 | 1,055 | 1,051 |

### EXAMPLE 4

### Lithographic Evaluation

For the purpose of evaluative lithographic experiments, a BARC formulation containing P1 (Example 1) was prepared by dissolving 0.4 g of the polymer in 10 g of cyclopentanone. The prepared BARC formulation was spin-coated for 30 seconds onto a silicon wafer. The BARC layer was then baked at 150° C. for 60 seconds on a vacuum hot plate to produce a film thickness of about 900 Å. Next, a 193 nm single layer resist (as described in U.S. patent application Ser. No. 10/753,989, filed Jan. 8, 2004) was spin-coated for 30 seconds onto the BARC material layer. The photoresist layer was soft-baked at 110° C. for 60 seconds on a vacuum hot plate to produce a film thickness of about 2400 Å. The wafers were then exposed to 193 nm radiation (ASML scanner, 0.75 NA). The exposure pattern was an array of lines and spaces of varying dimensions down to 0.09 μm. The exposed wafers were post-exposure baked on a vacuum hot plate at 110° C. for 90 seconds. The wafers were then puddle developed using 0.263 N TMAH developer for 60 seconds. The resulting patterns of the photoresist imaging layer were then examined by scanning electron microscopy (SEM). Patterns of line/space pairs of 110 nm and above were readily distinguished and appeared sharply defined with clean profiles and without standing wave.

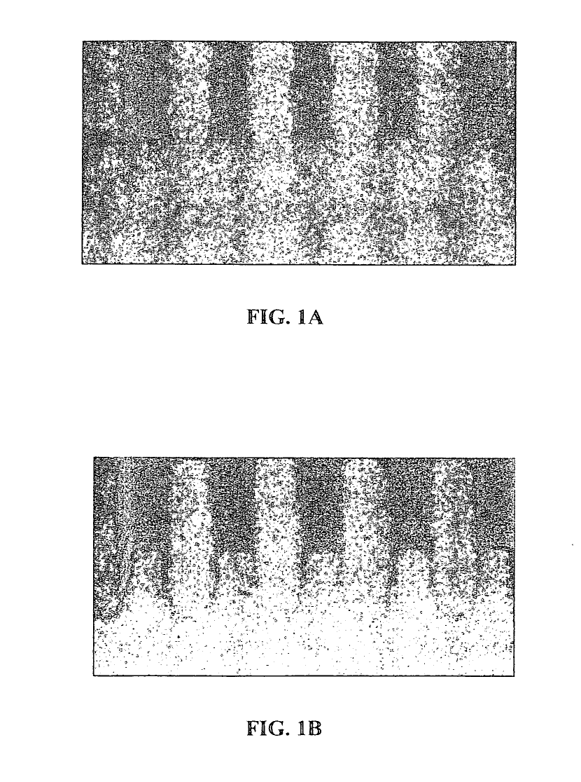

FIG. 1A is a partial sectional view of the patterned resist on HMDS-Si without a BARC, which shows sloped profiles and severe standing waves. In contrast, FIG. 1B is a partial sectional view of the patterned resist on a coating of the inventive antireflective composition, which shows clean profiles without any standing waves or line collapse.

### EXAMPLE 5

### Lithographic Evaluation

For the purpose of evaluative lithographic experiments, a BARC formulation containing P1 (Example 1) was prepared by dissolving 0.4 g of the polymer in 10 g of cyclopentanone. The prepared BARC formulation was spin-coated for 30 seconds onto a silicon wafer. The BARC layer was then baked at 150° C. for 60 seconds on a vacuum hot plate to produce a film thickness of about 900 Å. Next, a 193 nm bilayer resist (as described in U.S. Pat. No. 6,770,419 B2) was spin-coated for 30 seconds onto the BARC material layer. The photoresist layer was soft-baked at 130° C. for 60 seconds on a vacuum hot plate to produce a film thickness of about 1700 Å. The wafers were then exposed to 193 nm radiation (ASML scanner, 0.75 NA). The exposure pattern was an array of lines and spaces of varying dimensions down to 90 nm. The exposed wafers were post-exposure baked on a vacuum hot plate at 110° C. for 90 seconds. The wafers were then puddle developed using 0.263 N TMAH developer for 60 seconds. The resulting patterns of the photoresist imaging layer were then examined by scanning electron microscopy (SEM). Patterns of line/space pairs of 100 nm and above were readily distinguished and appeared sharply defined with clean profiles and without standing wave.

While the present invention has been particularly shown and described with respect to preferred embodiments thereof, it will be understood by those skilled in the art that the foregoing and other changes in forms and details may be made without departing from the spirit and scope of the invention. It is therefore intended that the present invention not be limited to the exact forms and details described and illustrated but fall within the scope of the appended claims.

Having thus described our invention in detail, what we claim as new and desire to secure by the Letters Patent is:

1. An antireflective coating composition for applying between a substrate surface and a photoresist composition, said antireflective coating composition comprising a polymer including at least one monomer unit containing a lactone moiety and at least one monomer unit containing an absorbing moiety.

2. The antireflective coating composition of claim 1 wherein said composition is organic solvent-strippable, insoluble in an aqueous alkaline developer for the photoresist composition after exposure to an imaging radiation, and inert to contact reactions with the photoresist composition.

3. The antireflective coating composition of claim 1, wherein the at least one monomer unit containing a lactone moiety has the following structure: 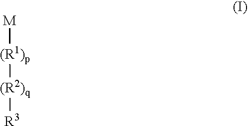
wherein M is a polymerizable backbone moiety; R¹ is a linkage moiety selected from the group consisting of —C(O)O—, —C(O)—, —OC(O)—, and —OC(O)C(O)O—; R² is an alkylene group having 1 to 10 carbon atoms, an arylene group having 5 to 20 atoms, a perfluorinated alkylene group having 1 to 10 carbon atoms, a semifluorinated alkylene group having 1 to 10 carbon atoms, a perfluorinated arylene group having 5 to 20 carbon atoms, or a semifluorinated arylene group having 5 to 20 carbon atoms; R³ is a lactone moiety having 3 to 20 carbon atoms; and p and q are the same or different, and are an integer of 0 or 1.

4. The antireflective coating composition of claim 3, wherein M is a polymerizable backbone moiety having one of the following two structures: 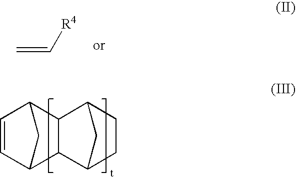
wherein R⁴ is a hydrogen atom, an alkyl group having 1 to 20 carbon atoms, a perfluorinated alkyl group having 1 to 20 carbon atoms, a semifluorinated alkyl group having 1 to 20 carbon atoms, or CN; t is an integer of 0 to 3.

5. The antireflective coating composition of claim 3, wherein R³ is selected from the group consisting of a beta-lactone, a gamma-lactone, or a delta-lactone.

6. The antireflective coating composition of claim 5, wherein R³ is selected from the group consisting of beta-propiolactone, gamma-butyrolactone, 2,6-norbornane-gamma-carbolactone, and 2,6-norbornane-delta-carbolactone.

7. The antireflective coating composition of claim 3, wherein the at least one monomer unit has a structure selected from one of the following:

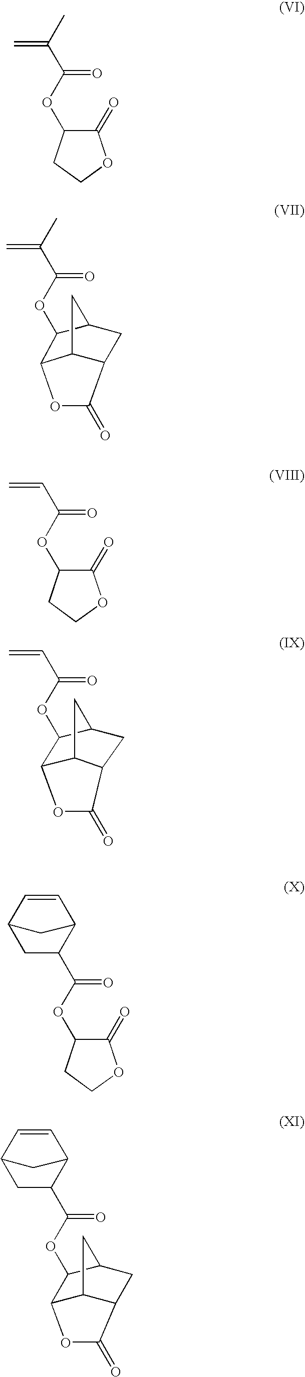

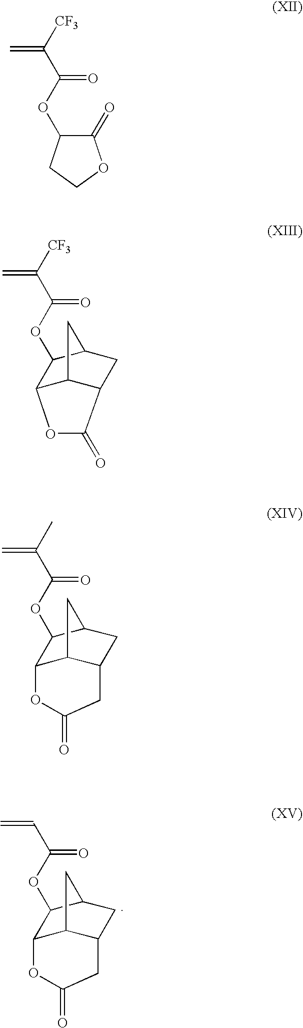

8. The antireflective coating composition of claim 1, wherein the absorbing moiety comprises an aromatic compound.

9. The antireflective coating composition of claim 8, wherein the aromatic compound is selected from the group unsubstituted benzene, substituted benzene, unsubstituted naphthalene, and substituted naphthalene.

10. The antireflective coating composition of claim 1, wherein the lactone moiety and the absorbing moiety are on the same monomer unit.

11. The antireflective coating composition of claim 2, which is insoluble in a photoresist casting solvent selected from the group consisting of esters and ethers.

12. The antireflective coating composition of claim 2, which is strippable by an organic solvent selected from the group consisting of a lactone, a ketone, and a mixture thereof.

13. The antireflective coating composition of claim 12, wherein the ketone is cyclohexanone or cyclopentaone; and the lactone is gamma-butyrolactone, gamma-valerolactone, or delta-valerolactone.

14. The antireflective coating composition of claim 1, wherein the polymer has a tunable weight average molecular weight ranging from about 5K Daltons to about 200K Daltons.

15. The antireflective coating composition of claim 1, which has a refractive index (n) in the range from about 1.4 to about 2.2 at an imaging wavelength of an overlying photoresist layer.

16. The antireflective coating composition of claim 1, which has and an absorption parameter (k) in the range from about 0.1 to about 1.0 at an imaging wavelength of an overlying photoresist layer.

17. A method of forming a patterned material feature on a substrate, said method comprising:
(a) providing a material surface on a substrate,
(b) forming a layer of antireflective coating over the material surface, said antireflective coating comprising a polymer including at least one monomer unit containing a lactone moiety and at least one monomer unit containing an absorbing moiety,
(c) forming a photoresist layer over said antireflective coating,
(d) patternwise exposing the photoresist layer to imaging radiation thereby creating a pattern of radiation-exposed regions in the photoresist layer,
(e) selectively removing portions of the photoresist layer to expose portions of the antireflective coating,
(f) selectively removing the exposed portions of the antireflective coating to expose portions of the material surface, and
(g) transferring the pattern to the material surface at the exposed portions of the material, thereby forming the patterned material feature.

18. The method of claim 17, wherein the wavelength for the imaging radiation is 193 nm.

19. The method of claim 17, further comprising, prior to the step of forming a layer of a photoresist composition over the antireflective layer, the step of baking the antireflective coating at temperature of about 90° C. to about 150° C.

20. The method of claim 17, wherein portions of the antireflective layer are removed by reactive ion etching.

21. The method of claim 17, wherein said transferring step (g) comprises etching said exposed portions of the material surface or ion implanting at said exposed portions of the material surface.
